(19) United States
(12) Patent Application Publication
(10) Pub. No.: US 2025/0150878 A1
(43) Pub. Date: May 8, 2025

(54) ACCESS NETWORK MONITORING IN A WIRELESS FEDERATION

(71) Applicant: Cisco Technology, Inc., San Jose, CA (US)

(72) Inventor: Mark Grayson, Maidenhead (GB)

(73) Assignee: Cisco Technology, Inc., San Jose, CA (US)

(21) Appl. No.: 18/911,891

(22) Filed: Oct. 10, 2024

Related U.S. Application Data
(60) Provisional application No. 63/589,063, filed on Oct. 10, 2023.

(51) Int. Cl. H04W 24/10; H04W 48/16

(52) U.S. Cl. CPC H04W 24/10; H04W 48/16

(57) ABSTRACT

Access network monitoring in a wireless federation may be provided. A plurality of access requests may be received from a probe device. Each of the plurality of access requests may comprise access request information. Next, an availability metric may be determined based on an amount of the plurality of access requests received and the access request information. The availability metric may then be reported.

### RELATED APPLICATION

Under provisions of 35 U.S.C. § 119(e), Applicant claims the benefit of U.S. Provisional Application No. 63/589,063 filed Oct. 10, 2023, which is incorporated herein by reference.

### TECHNICAL FIELD

The present disclosure relates generally to providing access network monitoring in a wireless federation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing access network monitoring in a wireless federation;

FIG. 2 is a flow chart of a method for providing access network monitoring in a wireless federation;

FIG. 3 illustrates receiving a plurality of access requests from a probe device; and

FIG. 4 is a block diagram of a computing device.

### DETAILED DESCRIPTION

### Overview

Access network monitoring in a wireless federation may be provided. A plurality of access requests may be received from a probe device. Each of the plurality of access requests may comprise access request information. Next, an availability metric may be determined based on an amount of the plurality of access requests received and the access request information. The availability metric may then be reported.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The success of a wireless federation may rely on the commitment of those providers to the service levels that have been defined in the federation's legal framework. The availability of Identity Providers (IDPs) may be derived by running scripts that re-run every monitoring period where the scripts then populate tables that may be used to analyze availability of different systems. OpenRoaming operates such a system to monitor IDP systems that then populate the results. A similar system may be required to monitor the availability of Access Network Providers (ANPs), although the coordination of such a distributed system may need to be agreed.

Embodiments of the disclosure may provide a system and process that may facilitate the coordination of an access monitoring technique that may scale to operate across a loosely coupled federation. Embodiments of the disclosure may provide a distributed system that may be able to determine the availability of access networks across a federation where the configuration of probes sent by individual access networks may be encoded in a Remote Authentication Dial-In User Service (RADIUS) message to then allow a remote server to automatically determine the availability of each access network.

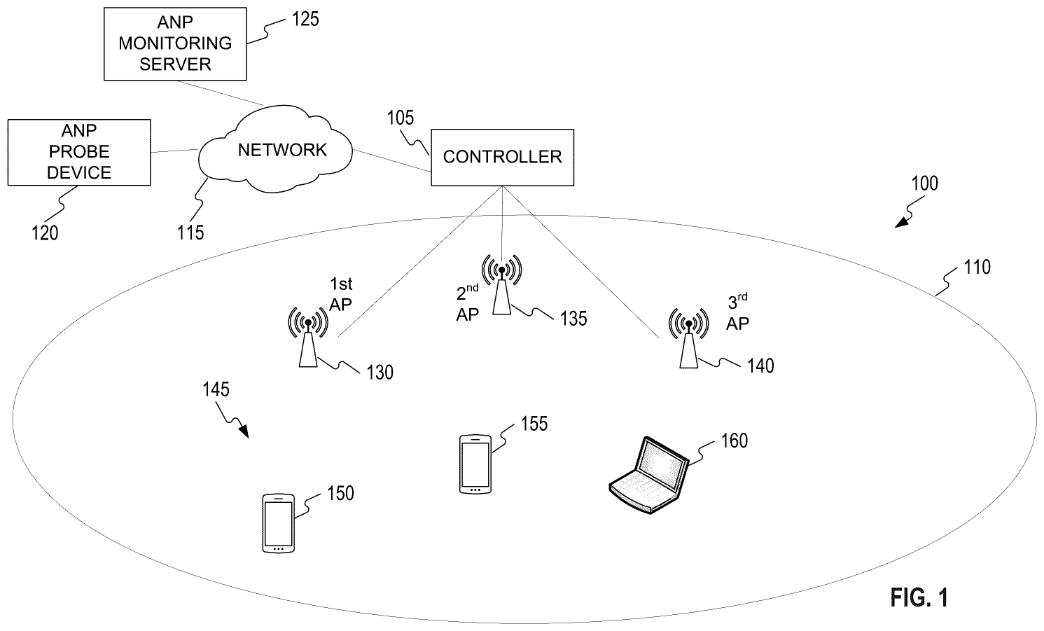

FIG. 1 shows an operating environment 100 for providing access network monitoring in a wireless federation. As shown in FIG. 1, operating environment 100 may comprise a controller 105, a coverage environment 110, a network 115, an Access Network Provider (ANP) probe device 120, and an ANP monitoring server 125. Coverage environment 110 may comprise, but is not limited to, a Wireless Local Area Network (WLAN) comprising a plurality of Access Points (APs) that may provide wireless network access (e.g., access to the WLAN) for devices. The plurality of APs may comprise a first AP 130, a second AP 135, and a third AP 140. Each of the plurality of APs may be compatible with specification standards such as, but not limited to, the Institute of Electrical and Electronics Engineers (IEEE) 802.11 specification standard for example.

A plurality of devices 145 may be deployed in coverage environment 110. The plurality of APs may provide wireless network access to plurality of devices 145 as the devices move within coverage environment 110. Coverage environment 110 may comprise an outdoor or indoor wireless environment for Wi-Fi or any type of wireless protocol or standard.

Plurality of devices 145 may comprise a first client device 150, a second client device 155, and a third client device 160. Ones of plurality of devices 145 may comprise, but are not limited to, a smart phone, a personal computer, a tablet device, a mobile device, a telephone, a remote control device, a set-top box, a digital video recorder, an Internet-of-Things (IoT) device, a smart watch, a smart Television (TV), a wireless docking station, a network computer, a router, an AR/VR device, an Automated Transfer Vehicle (ATV), a drone, an Unmanned Aerial Vehicle (UAV), a smart wireless light bulb, or other similar microcomputer-based device.

Controller 105 may comprise a Wireless Local Area Network controller (WLC) and may provision and control coverage environment 110 (e.g., a WLAN). Controller 105 may allow plurality of client devices 145 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide access network monitoring in a wireless federation.

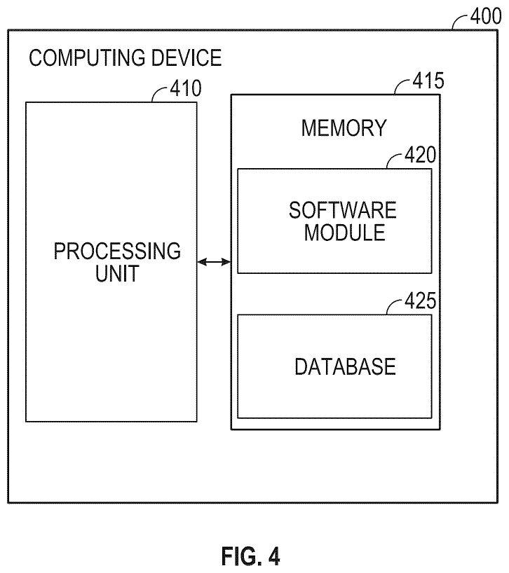

The elements described above of operating environment 100 (e.g., controller 105, ANP probe device 120, ANP monitoring server 125, first AP 130, second AP 135, third AP 140, first client device 150, second client device 155, and third client device 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

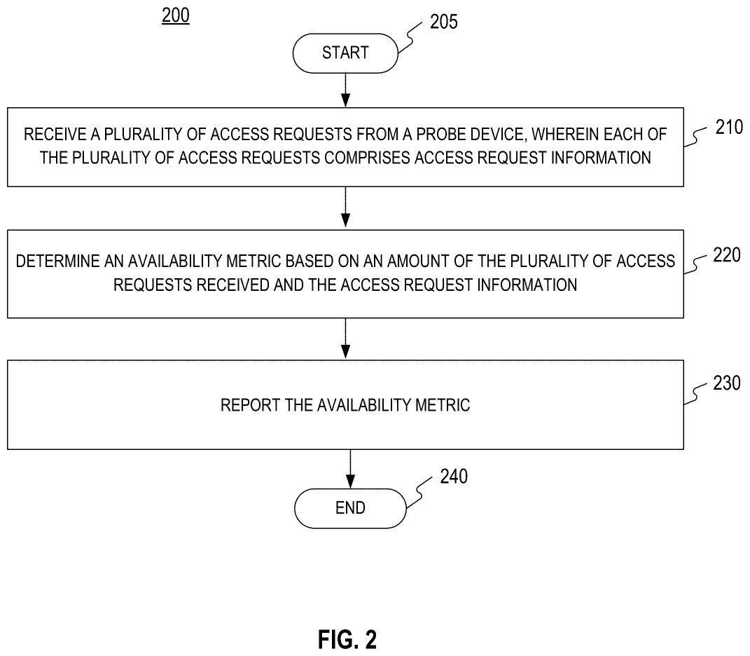

FIG. 2 is a flow chart setting forth the general stages involved in a method 200 consistent with embodiments of the disclosure for providing access network monitoring in a wireless federation. Method 200 may be implemented using computing device 400 as described in more detail below with respect to FIG. 4. Computing device 400 may be embodied by ANP monitoring server 125 for example. Ways to implement the stages of method 200 will be described in greater detail below.

Method 200 may begin at starting block 205 and proceed to stage 210 where ANP monitoring server 125 may receive a plurality of access requests from ANP probe device 120. Each of the plurality of access requests may comprise access request information. For example, embodiments of the disclosure may re-use the Extensible Authentication Protocol over LAN (EAPOL) test approach. However, instead of defining the Extensible Authentication Protocol (EAP) client to authenticate using some known credentials, embodiments of the disclosure may define the use of EAP credentials that may be specifically not supported by the IDP, in which case the IDP (e.g., ANP monitoring server 125) may immediately respond with an Access-Reject.

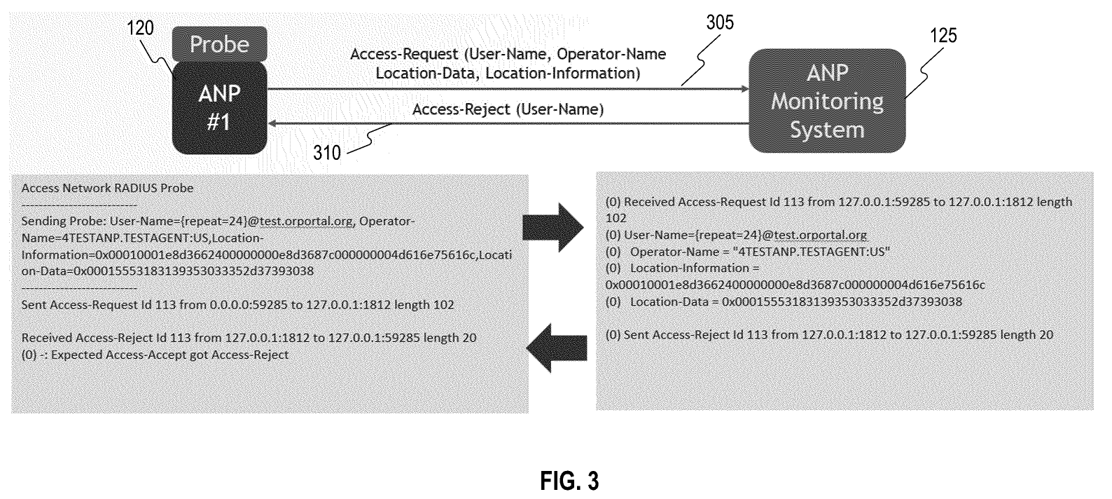

In one embodiment, the EAP client (i.e., ANP probe device 120) may be configured to use a realm supported by the federation operator (e.g., test.orportal.org). Embodiments of the disclosure may embed, in the access request, details of the EAP client information pertaining to the configuration of the EAP client access request. These details may be embedded in the access request information in the access request. FIG. 3 illustrates an access request 305 in more detail.

A Network Access Identifier (NAI) may comprise “username@realm”. The username may identify a terminal, and the realm may identify an Internet domain of a Network Access Server (NAS). In one embodiment, the username portion of the NAI may be used to encode the expected repetition period (i.e., periodicity) of the EAP client (i.e., ANP probe device 120). In addition, the username portion of the NAI may be used to encode a date (or datetime) until which the access network will continue to repeat the sending of the EAP exchange (i.e., expiry). The following are examples of an access request:
Example 1) repeat0@test.orportal.org: May be used to signal a one shot EAP exchange with no expectation of repeated operations.
Example 2) repeat24/until2024.01.26@test.orportal.org: May be used to terminate any on-going repeated checking (until date is today's date of 2024 Jan. 26).
Example 3) repeat48/until2024.03.26@test.orportal.org: May be used to
   a) establish repeated probing every 48 hours until2024.03.26; and
   b) to signal a repeated probe.

In the example 3 above, this may mean that ANP probe device 120 intends to send the plurality of access requests comprising 30 access requests over the next 60 days. However, in some cases, not all the access requests may be sent from that ANP probe device 120 because ANP probe device 120 may not be available to send them all. For example, ANP probe device 120 may only send 15 access requests and not 30 over the aforementioned 60 day period due to unavailability.

From stage 210, where ANP monitoring server 125 receives the plurality of access requests from ANP probe device 120, method 200 may advance to stage 220 where ANP monitoring server 125 may determine an availability metric based on an amount of the plurality of access requests received and the access request information. For example, the RADIUS server of test.orportal.org (i.e., ANP monitoring server 125) may be then used to record the EAP exchanges (i.e., the plurality of access requests) and to reject all of them. FIG. 3 illustrates an access rejection 310 in more detail. The RADIUS server may record attributes (i.e., access request information) from the received plurality of access requests and use them to calculate the availability metric for the ANP network associated with ANP probe device 120.

For example, if the access request information indicates that ANP probe device 120 intends to send the plurality of access requests comprising 30 access requests over the next 60 days and ANP monitoring server 125 receives all 30 access requests over the 60 days, then ANP monitoring server 125 may determine an availability metric of 100%. However, if the access request information indicates that ANP probe device 120 intends to send the plurality of access requests comprising 30 access requests over the next 60 days and ANP monitoring server 125 only receives 15 access requests over the 60 days, then ANP monitoring server 125 may determine an availability metric of 50%.

Once ANP monitoring server 125 determines the availability metric based on the amount of the plurality of access requests received and the access request information in stage 220, method 200 may continue to stage 230 where ANP monitoring server 125 may report the availability metric to an authority. For example, the ANP may have a legal obligation (e.g., by a service level agreement) to provide at least a 90% availability metric. If a 100% availability metric is reported, then ANP has met its obligation in this example. However, if a 50% availability metric is reported, then ANP has not met its obligation in this example. When location information is included in the access request information, ANP monitoring server 125 may record and monitor the location of the realm of ANP probe device 120. Once ANP monitoring server 125 reports the availability metric in stage 230, method 200 may then end at stage 240.

Embodiments of the disclosure may apply to environments that include any number of ANP probe devices and is not limited to just one ANP probe device 120. In other words, method 200 may be applied to any number ANP probe devices corresponding to respective domains and operating in parallel.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing access network monitoring in a wireless federation as described above with respect to FIG. 2. Computing device 400, for example, may provide an operating environment for controller 105, ANP probe device 120, ANP monitoring server 125, first AP 130, second AP 135, third AP 140, first client device 150, second client device 155, and third client device 160. Controller 105, ANP probe device 120, ANP monitoring server 125, first AP 130, second AP 135, third AP 140, first client device 150, second client device 155, and third client device 160 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving a plurality of access requests from a probe device, wherein each of the plurality of access requests comprises access request information;
determining an availability metric based on an amount of the plurality of access requests received and the access request information; and
reporting the availability metric.

2. The method of claim 1, wherein the access request information comprises realm information.

3. The method of claim 1, wherein the access request information comprises periodicity information.

4. The method of claim 1, wherein the access request information comprises expiry information.

5. The method of claim 1, further comprising providing a plurality of responses respectively to each of the plurality of access requests.

6. The method of claim 5, wherein each of the plurality of responses comprises a rejection.

7. The method of claim 1, wherein the probe device comprises an Access Network Provider (ANP) probe device.

8. The method of claim 1, wherein the access request information comprises location information associated with the probe.

9. A system comprising:
a memory storage; and
a processing unit coupled to the memory storage, wherein the processing unit is operative to:
receive a plurality of access requests from a plurality of probe devices, wherein each of the plurality of access requests comprises access request information and where the individual probe devices are able to separately configure their respective access request information;
determine an availability metric for each of the respective probe devices based on an amount of the plurality of access requests received from an individual probe device and the access request information; and
report the availability metric.

10. The system of claim 9, wherein the access request information comprises realm information.

11. The system of claim 9, wherein the access request information comprises periodicity information.

12. The system of claim 9, wherein the access request information comprises expiry information.

13. A non-transitory computer-readable medium that stores a set of instructions which when executed perform a method executed by the set of instructions comprising:
receiving a plurality of access requests from a probe device, wherein each of the plurality of access requests comprises access request information;
determining an availability metric based on an amount of the plurality of access requests received and the access request information; and
reporting the availability metric.

14. The non-transitory computer-readable medium of claim 13, wherein the access request information comprises realm information.

15. The non-transitory computer-readable medium of claim 13, wherein the access request information comprises periodicity information.

16. The non-transitory computer-readable medium of claim 13, wherein the access request information comprises expiry information.

17. The non-transitory computer-readable medium of claim 13, further comprising providing a plurality of responses respectively to each of the plurality of access requests.

18. The non-transitory computer-readable medium of claim 17, wherein each of the plurality of responses comprises a rejection.

19. The non-transitory computer-readable medium of claim 13, wherein the probe device comprises an Access Network Provider (ANP) probe device.

20. The non-transitory computer-readable medium of claim 13, wherein the access request information comprises location information associated with the probe.
